(19) United States
(12) Patent Application Publication
(10) Pub. No.: US 2007/0019024 A1
(43) Pub. Date: Jan. 25, 2007

(54) Image forming apparatus and image forming method

(75) Inventors: Kouichi Sanpei, Kanagawa (JP); Hiroshi Nou, Kanagawa (JP); Akira Iwaishi, Kanagawa (JP); Mitsuhiro Mori, Kanagawa (JP)

Correspondence Address: MORGAN LEWIS & BOCKIUS LLP, 1111 PENNSYLVANIA AVENUE NW, WASHINGTON, DC, 20004, US

(73) Assignee: Fuji Xerox Co., Ltd.

(21) Appl. No.: 11/398,528

(22) Filed: Apr. 6, 2006

(30) Foreign Application Priority Data
Jul. 20, 2005 (JP) P2005-210343

(51) Int. Cl. B41J 29/38

(52) U.S. Cl. 347/16

(57) ABSTRACT

An image forming apparatus includes a flash fixing section having at least one flash lamp, the flash fixing section fixing a toner image onto a recording medium by light energy being emitted from the flash lamp, a detecting section which detects the light energy emitted from the flash lamp, the detecting section being provided at a position facing the flash fixing section, and a determining section which determines a type of the recording medium based on a value of the light energy detected by the detecting section and a relationship between light energy values and types of a recording medium.

This application claims foreign priority based on Japanese Patent application No. 2005-210343, filed Jul. 20, 2005, the content of which is incorporated herein by reference in its entirety.

### BACKGROUND

1. Technical Field

The present invention relates to an image forming apparatus such as a printer utilizing a dry electrophotographic system, and also relates to an image forming method thereof. In particular, the present invention relates to an image forming apparatus such as a high-speed printer equipped with a flash fixing device which fixes an unfixed toner image onto a recording medium by making a flash lamp emit light and using the light energy emitted from the flash lamp.

2. Related Art

An image forming apparatus such as a printer utilizing the dry electrophotographic system has been configured in the following manner so as to form an image. A toner image is formed on an image carrying member such as a photoreceptor drum in accordance with image information, and the toner image formed on the image carrying member is transferred to a recording medium. Thereafter, fixing energy such as heat energy is applied to the toner image thus transferred to the recording medium so as to melt the toner image which is formed of a powder toner. Accordingly, the image is fixed onto the recording medium.

The image forming apparatus can form an image on various types of the recording medium. As one example of the image forming apparatus, a high-speed printer can form an image at a high speed on a continuous paper as the recording medium. The high-speed printer uses a non-contact flash type fixing system which uses light energy from a flash lamp, as a method for applying the fixing energy to the powder toner so as to fix the powder toner onto the recording medium. This flash fixing system is capable of applying a large amount of energy instantaneously to the recording medium without affecting transport of the recording medium moving at a high speed.

The printer employing the non-contact flash type fixing system has such a large advantage that the recording medium is not limited in type since the printer directly applies light energy onto the powder toner on the recording medium. Printing is possible on various types of paper as the recording medium, including a thin paper such as a newspaper, a thick paper such as a drafting paper, a surface-coated paper, a whitish paper, an yellowish paper, and the like.

Accordingly, various types of the paper are used. In addition to those described above, plain paper, thin paper thinner than the plain paper, thick paper, and coated paper having a coating on a surface of the plain paper or the thick paper are used. Considering the thickness, the presence or absence of the coating, the colors of the paper, and the like, in general, seven or eight types or more types of the paper are used.

In the printer employing the non-contact flash type fixing system, endothermic and exothermic characteristics of paper vary depending on the type of paper, and also conditions for suitable flash fixing vary. Therefore, the fixing conditions are managed so as to be set separately corresponding to the type of paper. Accordingly, an operator of the high-speed printer confirms the type of the paper upon placing the paper on the printer, and manipulates an operation panel so as to provide prescribed fixing conditions suitable for the type of paper confirmed. Thus, setting is performed so as to provide the prescribed fixing conditions.

Upon once starting printing operation of the high-speed printer, a large amount of paper is printed in a short period of time. Therefore, there is such a problem that when the operator sets the paper of an improper type on the printer, or inputs an improper value as the fixing conditions, the printing operation is carried out on a paper different from the paper designated by the operator, or on a paper of which fixing conditions differs from the designated fixing conditions by the operator. Thus, a large amount of paper with fixing failure is generated.

In order to solve the problem, the operator confirms the type of paper upon placing the paper on the printer so as to avoid the mistake of the paper setting. However, human-induced careless mistake cannot be reliably prevented from occurring, which still brings about the problem of generating a large amount of paper with fixing failure.

### SUMMARY

According to an aspect of the present invention, an image forming apparatus of the invention includes: a flash fixing section having at least one flash lamp, the flash fixing section fixing a toner image onto a recording medium by light energy being emitted from the flash lamp; a detecting section which detects the light energy emitted from the flash lamp, the detecting section being provided at a position facing the flash fixing section; and a determining section which determines a type of the recording medium based on a value of the light energy detected by the detecting section and a relationship between light energy values and types of a recording medium.

### BRIEF DESCRIPTION OF THE DRAWINGS

An exemplary embodiment of the present invention will be described in detail based on the following figures, wherein:

FIG. 1 illustrates a high-speed printer as an image forming apparatus according to a first exemplary embodiment of the invention;

FIGS. 2A and 2B are cross sectional diagrams showing examples of a flash fixing device used in the high-speed printer as an image forming apparatus according to a first exemplary embodiment of the invention;

FIG. 3 is a perspective diagram showing a flash fixing device used in the high-speed printer as an image forming apparatus according to a first exemplary embodiment of the invention;

FIG. 4 is a plane diagram showing a flash fixing device used in the high-speed printer as an image forming apparatus according to a first exemplary embodiment of the invention;

FIG. 5 is a block diagram showing a controller of the high-speed printer as an image forming apparatus according to a first exemplary embodiment of the invention;

FIG. 6 is a diagram showing a data table in which a relationship between detected value of a light receiving sensor and a type of a recording medium is stored in advance;

FIG. 7 is a graph showing change of light amount of flash lamps in the flash fixing device;

FIG. 8 is a graph showing a relationship between thickness of paper and transmittance of light of the flash lamps;

FIG. 9 is a diagram showing a relationship between ream weight and basis weight of paper; and

FIG. 10 is a graph showing a relationship between elapsing time from light emission of the flash lamps of the flash fixing device and temperature of paper.

### DETAILED DESCRIPTION

An exemplary embodiment of the invention will be described with reference to the drawings.

### FIRST EXEMPLARY EMBODIMENT

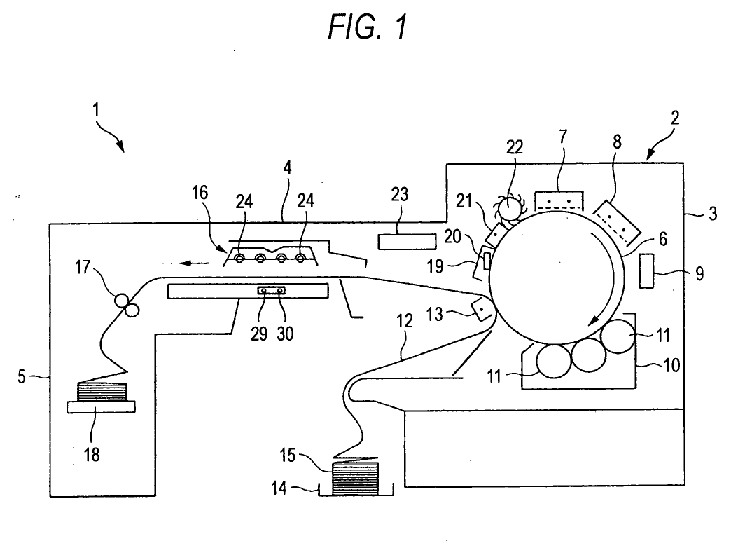

FIG. 1 illustrates a high-speed printer as an image forming apparatus according to a first exemplary embodiment of the invention.

A high-speed printer 1 can print an image at a high speed on a continuous paper, which is a paper in a continuous long sheet form, as shown in FIG. 1. The high-speed printer 1 has a printer main body 2 including an image forming section 3 on the right side, a fixing section 4 on the center and a paper delivery section 5 on the left side, and the printer main body 2 is formed in a gate-like configuration having relatively a larger right side portion. The image forming section 3 of the printer main body 2 has a photoreceptor drum 6 as an image carrying member disposed rotatablly at a high speed in a direction shown by the arrow in the figure. The photoreceptor drum 6 has a large diameter of about 300 mm, and is configured with an electroconductive cylindrical body being coated with a photoreceptor layer which is made of a photoconductive material such as OPC (organic photo conductor), amorphous-Si (amorphous silicon), and Se (selenium), on its surface. A pair of first charging devices 7 and 8 such as a scorotron are disposed on the upper side and the obliquely upper right side of the photoreceptor drum 6, and charge a surface of the photoreceptor drum 6 uniformly to a prescribed potential. An LED printer head 9 having an LED array as an image exposing section is disposed on the right side of the photoreceptor drum 6, and the image exposing section performs image exposure corresponding to image information on the surface of the photoreceptor drum 6 uniformly charged to the prescribed potential by the pair of first charging devices 7 and 8. The LED printer head 9 performs the image exposure on the surface of the photoreceptor drum 6 so as to form an electrostatic latent image corresponding to the image information.

The electrostatic latent image formed on the surface of the photoreceptor drum 6 is developed by a developing device 10 which is disposed from the obliquely right lower side to the lower side of the photoreceptor drum 6 so as to provide a toner image formed of a powder toner. The developing device 10 has triple developing rolls 11 so as to develop the electrostatic latent image formed on the photoreceptor drum 6 at a high speed in accordance with the photoreceptor drum 6 rotating at a high speed. The developing device 10 may employ either an one-component developing system or a two-component developing system.

A transfer charging device 13 having a corotron is disposed on the obliquely left lower side of the photoreceptor drum 6 as a transferring section which transfers the toner image formed on the photoreceptor drum 6 onto a continuous paper 12 as a recording medium. The toner image formed on the photoreceptor drum 6 is sequentially transferred to the continuous paper 12 through charging by the transfer charging device 13.

The continuous paper 12 as the recording medium is fed from a paper feeding section 14 disposed in the inner side of a lower end portion of the image forming section 3 of the printer main body 2. The continuous paper 12 is paper in a continuous long sheet form having fold lines (perforated lines) per one page. As shown in FIG. 1, a continuous paper set 15 of the folded continuous paper 12 is set in the paper feeding section 14.

Various types of paper are used as the continuous paper 12 depending on needs of users, and seven or eight types or more types of paper may be used such as plain paper, thin paper thinner than the plain paper, thick paper, coated paper having a coating on a surface of the plain paper or the thick paper, and paper colored to a prescribed color such as yellow.

As shown in FIG. 1, the continuous paper 12 on which the toner image is transferred from the photoreceptor drum 6 by the transfer charging device 13 is conveyed to the fixing section 4 by a conveying section which is not shown in the figure. Then, the unfixed toner image is fixed on the continuous paper 12 by a flash fixing device 16 disposed in the fixing section 4.

The continuous paper 12 on which the toner image is fixed by the flash fixing device 16 is ejected in a folded state by conveying rolls 17 to a paper output tray 18 disposed in the paper delivery section 5.

The surface of the photoreceptor drum 6 after completing the transferring process of the toner image is cleaned with a cleaning blade 20 of a cleaning device 19 so as to remove the remaining toner and the like. Then, antistatic cleaning is performed on the surface of the photoreceptor drum 6 by a static eliminator 21 having a corotron so as to remove the remaining charge, and the surface of the photoreceptor drum 6 is cleaned with a cleaning brush 22 so as to remove paper powder, toner powder, and the like. Thus, the photoreceptor drum 6 is prepared for the next image forming process.

In FIG. 1, numeral 23 denotes a flash controller which controls light emission (light emission frequency) of flash lamps 24 in the flash fixing device 16 which will be described later.

In the image forming apparatus of this exemplary embodiment having the flash fixing device which fixes the toner image onto the recording medium by making the flash lamps emit light and using light energy emitted from the flash lamps, a detecting section is provided at a position facing the flash lamps with the recording medium intervening therebetween, and the detecting section detects the light energy emitted from the flash lamps. In the image forming apparatus, furthermore, a determining section is provided which determines the type of the recording medium based on a detected value detected by the detecting section with reference to a table in which a relationship between the detected value and the type of the recording medium is stored in advance.

In this exemplary embodiment, a notifying section is also provided which notifies an operator of abnormality information in a case where the type of the recording medium determined by the determining section is different from the type of the recording medium being designated.

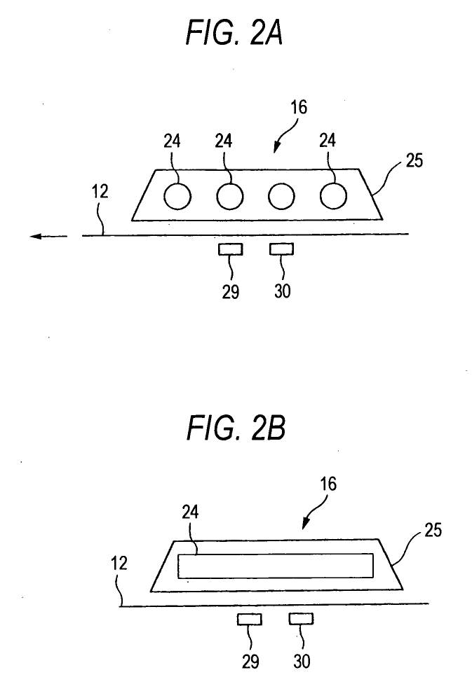

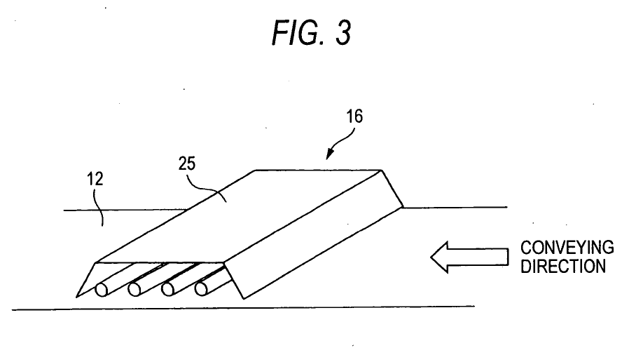

More specifically, in the high-speed printer of this exemplary embodiment, as shown in FIG. 1, the flash fixing device 16 is used as a fixing device, in which plural flash lamps 24 emit light so as to fix the unfixed toner image onto the continuous paper 12 with the light energy emitted from the flash lamps 24. As shown in FIG. 2A, in which the flash fixing device 16 is viewed from a direction perpendicular to the conveying direction of the paper 12, the flash fixing device 16 has the plural flash lamps 24. As shown in FIG. 3, the plural flash lamps 24 are disposed inside a reflection plate 25 in parallel to each other at constant intervals in the conveying direction of the continuous paper 12. The lower side of the flash lamps 24 is covered with a cover glass plate.

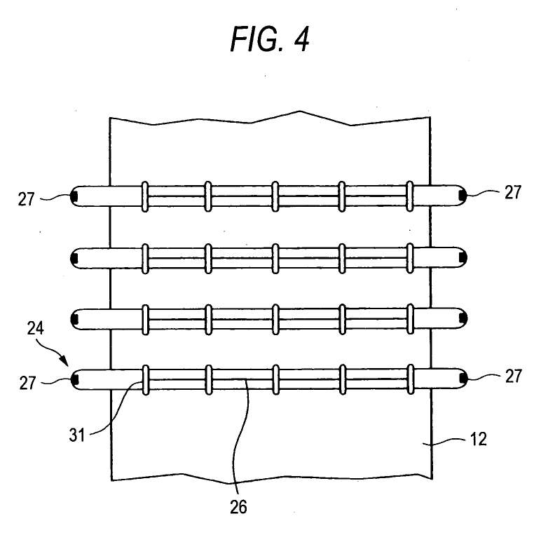

As shown in FIG. 4, the flash lamp 24 has a trigger wire 26 stretched in the longitudinal direction of the flash lamp 24 with plural trigger rings 31 attached on the outer periphery of the flash lamp 24. The plural flash lamps 24 are configured so that a high voltage is applied on electrodes 27 provided on both ends thereof, and simultaneously a prescribed high voltage is also applied on the trigger wire 26. Thus, the flash lamps 24 flash light, and the unfixed toner image is fixed onto the continuous paper 12 with the light energy emitted from the flash lamps 24. Conditions of light emission of the flash lamps 24 are set by the flash controller 23 depending on the type of the continuous paper 12.

In the high-speed printer 1 as shown in FIG. 1, two light receiving sensors 29 and 30 as the detecting section which detects light emitted from the flash lamps 24 are disposed at a position 28 facing the flash lamps 24 with the continuous paper 12 as the recording medium intervening therebetween. Each of the light receiving sensors 29 and 30 may be disposed at a position beneath any one of the plural flash lamps 24 as shown in FIG. 2A. Alternatively, both the light receiving sensors 29 and 30 may be arranged in the longitudinal direction of any one of the flash lamps 24 as shown in FIG. 2B, in which the flash fixing device 16 is viewed from the paper conveying direction.

As the first light receiving sensor (light amount sensor) 29 of the two light receiving sensors, a sensor capable of receiving light having a wavelength in a visible light region is used, for example. The first light receiving sensor 29 receives light emitted from the flash lamps 24 in the flash fixing device 16 directly without the continuous paper 12 intervening therebetween, or receives light emitted from the flash lamps 24 in the flash fixing device 16 through the continuous paper 12. Various types of sensors may be used as the first light receiving sensor 29, and one example thereof is an illuminance meter T-10M, manufactured by Konica Minolta.

As the second light receiving sensor (infrared ray sensor) 30 of the two light receiving sensors, a sensor capable of receiving energy of light having a wavelength in an infrared ray region is used, for example. The continuous paper 12 absorbs light emitted from the flash lamps 24 of the flash fixing device 16, and generates heat. The second light receiving sensor 30 detects light energy of the wavelength in the infrared ray region being emitted due to the heat generation of the continuous paper 12. Various types of sensors may be used as the second light receiving sensor 30, and one examples thereof is Thermopile (a trade name), manufactured by Ishizuka Electronics Corporation.

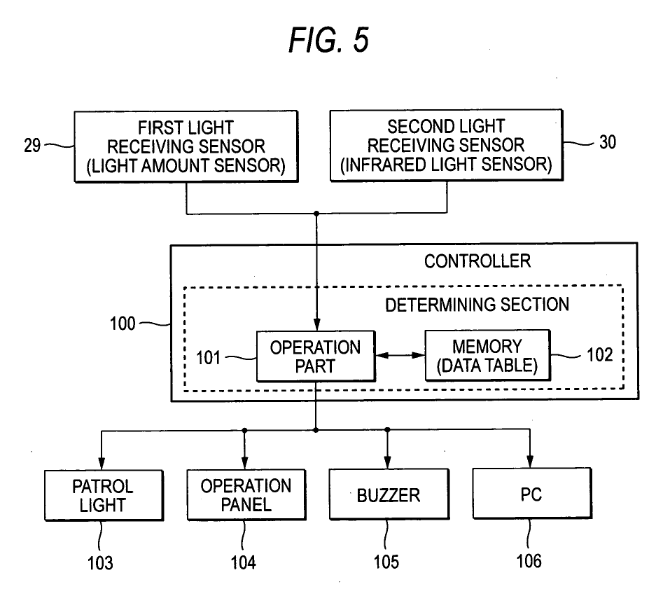

FIG. 5 is a diagram showing a control circuit of the high-speed printer according to the exemplary embodiment of the invention.

In FIG. 5, numeral 100 denotes a controller for controlling an operation of the high-speed printer, and the controller 100 has an operation part 101 including a CPU as a controller, etc., and a memory 102 including a ROM, a RAM, etc. Signals from the first and second light receiving sensors 29 and 30 as the detecting section are input in the operation part 101. The operation part 101 outputs a signal to the notifying section including a patrol light 103 which is a rotating lamp that rotates while lighting, a printer operation panel 104, a buzzer 105, a personal computer (PC) 106, etc. The operation part 101 also has a function of the determining section which determines the type of the recording medium based on the detected value detected by the light receiving sensors 29 and 30 as the detecting section, with reference to the memory 102 (a data table) in which the relationship between the detected value and the type of the recording medium is stored in advance.

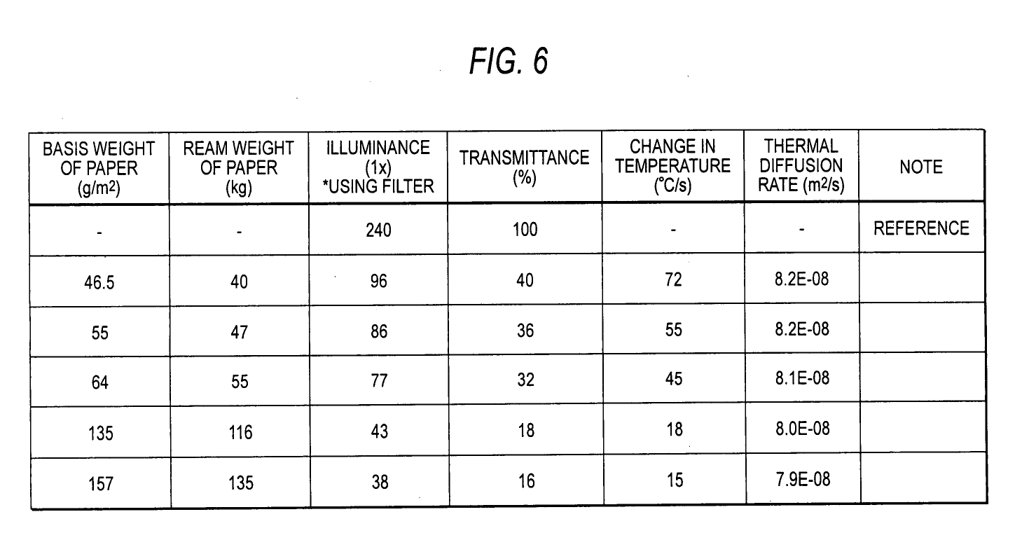

In the memory 102, a table as shown in FIG. 6 is stored in advance, which shows the relationship between the detected value detected by the light receiving sensors 29 and 30 and the type of the recording medium.

In the high-speed printer of the exemplary embodiment having the aforementioned configuration, wide variety of types of paper such as plain paper, thin paper, thick paper and coated paper having a coating on a surface of the plain paper or the thick paper are determined as described below. Thus, an image can be formed under conditions suitably adapted to the type of the recording medium, whereby a large amount of the recording medium with fixing failure can be reliably prevented from occurring.

In the high-speed printer according to the exemplary embodiment, as shown in FIG. 1, after charging the surface of the photoreceptor drum 6, while driving the photoreceptor drum 6 at a prescribed rotation speed, the electrostatic latent image is formed by performing the image exposure. Then, the electrostatic latent image formed on the surface of the photoreceptor drum 6 is developed by the developing device so as to form the toner image. The toner image is transferred to the continuous paper 12, and the unfixed toner image is then fixed onto the continuous paper 12 by the flash fixing device 16 so as to complete the printing operation of the image.

Upon carrying out the aforementioned printing operation, in the high-speed printer 1 as shown in FIG. 1, the continuous paper set 15 of the continuous paper 12 of a desired type that is designated by an operator depending on purpose of formation of the image is placed in the paper feeding section 14. Also, the fixing conditions are set, for example, by inputting values with the operation panel 104 corresponding to the type of the continuous paper 12. Then, the printing operation is started.

In order to convey the continuous paper 12 in the high-speed printer 1, a tip end portion of the continuous paper 12 is disposed and set along the conveying path of the continuous paper 12 so as to make the continuous paper 12 be automatically delivered to the paper output tray 18 in the paper delivery section 5. In a case where the high-speed printer 1 is configured so that the continuous paper 12 can be fed automatically, the continuous paper set 15 of the continuous paper 12 may be merely placed in the paper feeding section 14.

Prior to the start of the printing operation in the high-speed printer 1, the flash lamps 24 in the flash fixing device 16 are driven to emit light in such a state that the continuous paper 12 is not disposed in the flash fixing device 16, and the light emission amount from the flash lamps 24 is detected by the first light receiving sensor 29. The detected value of the light emission amount of the flash lamps 24 is temporarily stored in the memory 102.

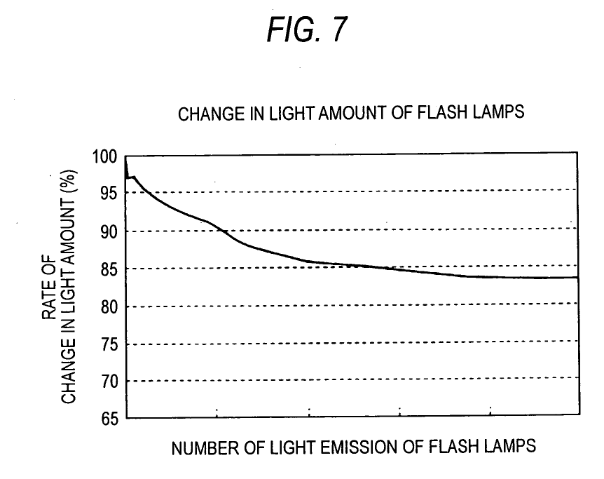

The light emission amount of the flash lamps 24 is gradually changed with a number of light emissions of the flash lamps 24 as shown in FIG. 7. A reference light emission amount is obtained by detecting the light emission amount of the flash lamps 24 prior to the start of the printing operation. Since the light emission amount of the flash lamps 24 is not largely changed in a short period of time, the light emission amount may be detected only once upon turning an the printer.

In the high-speed printer 1 as shown in FIG. 1, subsequently, the flash lamps 24 in the flash fixing device 16 are driven to emit light for a prescribed number of times (for example, four times) in such a state that the continuous paper 12 is disposed in the flash fixing device 16. The light amount received through the continuous paper 12 is detected by the first light receiving sensor 29 and the second light receiving sensor 30. The detected values of the first light receiving sensor 29 and the second light receiving sensor 30 are stored in the memory 102. At this time, the first light receiving sensor 29 detects the received light amount upon light emission of the flash lamps 24, but the second light receiving sensor 30 is configured so as to detect the received light amount with a delay in timing such as a prescribed delay (for example, 10 msec) from the last light emission of the flash lamps 24.

The operation part 101 determines the type of the continuous paper 12 by referring to the table stored in the memory 102 showing the relationship between the detected values of the first and second light receiving sensors 29 and 30 and the type of the continuous paper 12, as shown in FIG. 6.

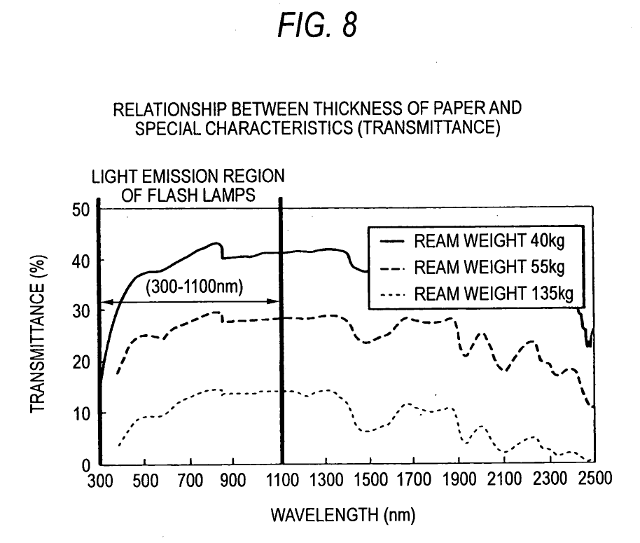

The transmitted light amount detected by the first light receiving sensor 29 is compared with the light emission amount of the flash lamps 24 that is directly detected so as to calculate a transmittance of the continuous paper 12 by the CPU 100. The transmittance of the continuous paper 12 varies depending on the thickness of the paper constituting the continuous paper 12. Since a light emission region (light emission wavelength) of the flash lamps 24 is about from 300 to 1,100 nm as shown in FIG. 8, a sensor capable of detecting an amount of light having a wavelength, for example, of 700 nm (red region) is used as the first light receiving sensor 29.

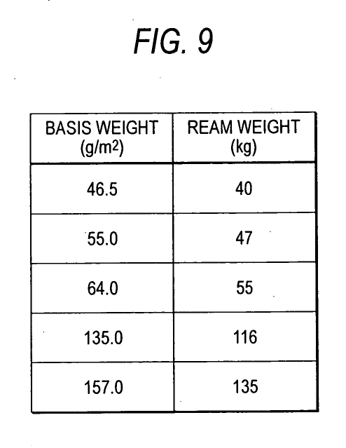

The operation part 101 determines as to whether the type of the continuous paper 12 in terms of thickness (ream weight) is 40 kg (thin paper), 55 kg (plain paper) or 135 kg (thick paper) by comparing the transmittance of the continuous paper 12 with, for example, a prescribed threshold value. A parameter indicating the thickness of the continuous paper 12 may be the ream weight, but a basis weight showing a weight per unit area may also be used. The ream weight and the basis weight have a relationship as shown in FIG. 9.

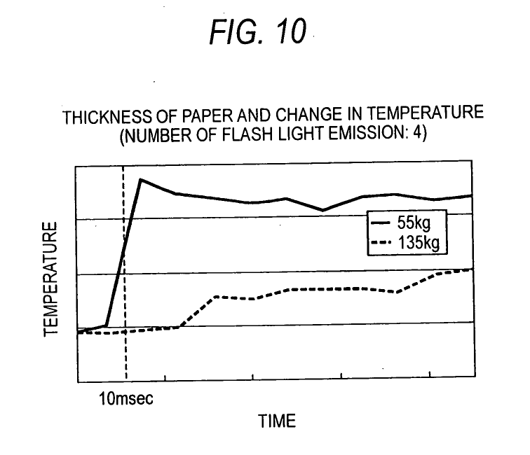

The received light amount in the infrared ray region detected by the second light receiving sensor 30 changes with lapse of time when light emission of the flash lamps 24 is performed for four times, as shown in FIG. 10, for example. Accordingly, the operation part 101 calculates the temperature of the continuous paper 12 after 10 msec from the start of the light emission of the flash lamps 24 based on the infrared ray amount detected by the second light receiving sensor 30 so as to detect the temperature.

The operation part 101 then determines as to whether the type of the continuous paper 12 in terms of the thickness (ream weight) is 40 kg (thin paper), 55 kg (plain paper) or 135 kg (thick paper) based on the temperature of the continuous paper 12 after 10 msec from the start of the light emission of the flash lamps 24. The operation part 101 may be constituted in such a manner that a gradient of the temperature of the continuous paper 12 after lapsing a prescribed period of time from the start of the light emission of the flash lamps 24 is calculated, and the thickness of the continuous paper 12 is determined based on the temperature gradient. Even though the thickness (ream weight) of the continuous paper 12 is the same, the temperature of the continuous paper 12 after lapsing 10 msec from the start of the light emission of the flash lamps 24 differs depending on the presence or absence of a coating, i.e., a paper having no coating or a coated paper. Therefore, it can be determined as to whether or not the continuous paper 12 is the coated paper by detecting the temperature of the continuous paper 12 even though the thickness (ream weight) of the continuous paper 12 is identical.

Based on the result of the aforementioned determination, the operation part 101 continues the printing operation in a case where the type of the continuous paper 12 thus determined is the same as the type set in advance. The operation part 101 notifies the operator of the abnormality information by the notifying section such as the rotating lamp 103 which rotates while lighting, the buzzer 105, and messages on the printer operation panel 104 and the personal computer 106, in a case where the type of the continuous paper 12 thus determined is different from the type set in advance. The operation part 101 may terminate the printing operation simultaneously with notifying the operator of the abnormality information.

As described above, according to the high-speed printer of the exemplary embodiment, wide variety of types of paper including plain paper, thin paper, thick paper and coated paper having a coating on the surface of the plain paper or the thick paper can be determined so as to form an image under conditions suitably adapted to the recording medium, whereby a large amount of the recording medium with fixing failure can be reliably prevented from occurring.

In the exemplary embodiment, a flash fixing device with plural flash lamps is described, but the present invention is not limited thereto, and a flash fixing device with a single flash lamp may alternatively be employed.

It will be apparent to those skilled in the art that various modifications and variations can be made to the described preferred embodiments of the present invention without departing from the spirit or scope of the invention. Thus, it is intended that the present invention cover all modifications and variations of this invention consistent with the scope of the appended claims and their equivalents.

What is claimed is:

1. An image forming apparatus comprising:
a flash fixing section having at least one flash lamp, the flash fixing section fixing a toner image onto a recording medium by light energy being emitted from the flash lamp;
a detecting section which detects the light energy emitted from the flash lamp, the detecting section being provided at a position facing the flash fixing section; and
a determining section which determines a type of the recording medium based on a value of the light energy detected by the detecting section and a relationship between light energy values and types of a recording medium.

2. The image forming apparatus as claimed in claim 1, further comprising:
a memory in which the relationship between the light energy values and the types of the recording medium is stored.

3. The image forming apparatus as claimed in claim 2, wherein the relationship between the light energy values and the types of the recording medium is stored as a table in the memory.

4. The image forming apparatus as claimed in claim 1, further comprising:
a designating section which designates a type of the recording medium to be used by a user; and
a notifying section which notifies the user of abnormality information in a case where the type of the recording medium determined in the determining section differs from the type of the recording medium designated in the designating section.

5. The image forming apparatus as claimed in claim 4, wherein the designating section and the notifying section have a common interface.

6. The image forming apparatus as claimed in claim 1, wherein the type of the recording medium determined in the determining section includes at least one of a thickness of the recording medium and a presence or absence of a coating on the recording medium.

7. The image forming apparatus as claimed in claim 1, wherein the detecting section detects at least one of an amount of light emitted from the flash lamp, an amount of light emitted from the flash lamp and transmitted through the recording medium, and a thermal characteristic value calculated from a result of heat generation of the recording medium due to absorption of light emitted from the flash lamp.

8. The image forming apparatus as claimed in claim 1, wherein an amount of light to be emitted from the flash lamp upon fixing is set at different values corresponding to the types of the recording medium.

9. The image forming apparatus as claimed in claim 1, wherein a timing of light emission from the flash lamp differs from a timing of detection in the detecting section.

10. The image forming apparatus as claimed in claim 1, wherein the detecting section detects the light energy when the recording medium intervenes between the detecting section and the flash fixing section.

11. An image forming method comprising:
fixing a toner image onto a recording medium by light energy being emitted from at least one flash lamp;
detecting the light energy emitted from the flash lamp; and
determining a type of the recording medium based on a value of the detected light energy and a relationship between light energy values and types of a recording medium.

12. The image forming method as claimed in claim 11, further comprising:
storing the relationship between the light energy values and the types of the recording medium in a memory in advance.

13. The image forming method as claimed in claim 12, wherein the relationship between the light energy values and the types of the recording medium is stored as a table in the memory.

14. The image forming method as claimed in claim 11, further comprising:
designating a type of the recording medium to be used by a user; and
notifying the user of abnormality information in a case where the determined type of the recording medium differs from the designated type of the recording medium.

15. The image forming method as claimed in claim 14, wherein the designating step and the notifying step are performed by using a common interface.

16. The image forming method as claimed in claim 11, wherein the determined type of the recording medium includes at least one of a thickness of the recording medium and a presence or absence of a coating on the recording medium.

17. The image forming method as claimed in claim 11, wherein the detecting step includes detecting at least one of an amount of light emitted from the flash lamp, an amount of light emitted from the flash lamp and transmitted through the recording medium, and a thermal characteristic value calculated from a result of heat generation of the recording medium due to absorption of light emitted from the flash lamp.

18. The image forming method as claimed in claim 11, further comprising:
setting an amount of light to be emitted from the flash lamp upon fixing at different values corresponding to the types of the recording medium.

19. The image forming method as claimed in claim 11, wherein a timing of light emission from the flash lamp differs from a timing of detection in the detecting step.
